(19) United States
(12) Patent Application Publication
(10) Pub. No.: US 2006/0031515 A1
(43) Pub. Date: Feb. 9, 2006

(54) Mobile ad-hoc internet sharing

(75) Inventors: Jozef Pieter Van Gassel, Eindhoven (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/533,736

(22) PCT Filed: Oct. 8, 2003
(86) PCT No.: PCT/IB03/04471

§ 371 Date: May 4, 2005

(30) Foreign Application Priority Data
Nov. 6, 2002 (EP) 02079628.0

(51) Int. Cl. G06F 15/16

(52) U.S. Cl. 709/227

(57) ABSTRACT

A method and a system for mobile ad-hoc Internet sharing. The system comprises a first portable device (10) that is provided with wireless communication capability (11) and that is enabled to identify a user A of the device (10), a second device (20I;20II) that is provided with wireless communication capability (21I;21II) and with capability (22I;22II) to connect to the Internet via an ISP, and that is enabled to identify a user B responsible for the connection, and an ISP (30). The method comprises wirelessly sending information from the first device (10) to the second device (20I;20II), for initiating a connection between the first device (10) and the ISP (30), forwarding the information from the second device (20I;20II) to the ISP (30), identifying, at the ISP (30), that the information is sent from user B and originates from user A, and initiating, at the ISP (30), registration for charging of an account (36) of user A for said connection.

The present invention relates to a method and a system for mobile ad-hoc Internet sharing.

In the near future the selection of small portable devices, starting with Personal Digital Assistants (PDA's) and mobile phones today, will steadily grow and include a wider range of devices each with their own local storage, processing, and often limited networking functionality. These devices are not only used at home or at the office to connect to desktop PCs or other devices but also while away. A likely scenario is a model where users carry around a multiple of single purpose information appliances connected together in a Personal Area Network (PAN). Some of these devices might be without User Interface (UI), others will have a UI and the devices including UI may be used to control the devices without UI. The range of capabilities will differ quite a bit among devices. Depending on the planned activities of the user he or she will carry only those devices that are of particular use for that specific purpose. Possible reasons for this differentiation in functionality are cost reduction, form-factor, battery-life etc.

Modern short range communication protocols like for instance Bluetooth and Universal Plug and Play already have the functionality to allow a device to discover other devices in its proximity and the associated services being delivered by those devices. Although most devices will have some sort of wired or wireless PAN networking technology it is not obvious that they will all include long distance connectivity like GSM, GPRS, UMTS etc. The long distance connectivity options are usually too expensive, in terms of both cost price and power consumption, to add to each device. Moreover, utilizing these types of connections is not for free, i.e there is some sort of subscription and billing scheme associated with these connections, as opposed to PAN networking technology where only the cost of the added functionality and usage, i.e. power consumtion, is an issue. Also the bandwidth is generally much lower over mobile networks such as GSM, GPRS and UMTS than the bandwidth that is available from wireless PAN and LAN networks. Therefore some applications, e.g. streaming video, may be impractical over GSM/GPRS/UMTS with the required quality.

Different solutions for different types of situations have been presented in the art for allowing connectivity to the Internet of “simple” PAN networked devices without long distance connectivity.

WO 01/56233 A1 discloses an integrated phone-based home gateway system which includes a broadband communication device, an analog modem, and a wireless interface which is integrated into a screen-phone for providing broadband communication service to home users. By means of this system, multiple users are able to access the Internet. The wireless interface allows in-home as well as to-home networking, provides automatic data and broadband initialization, configuration and service provisioning, routing and bridging functionality and allows resource sharing among home devices via the existing phone wire, wireless, coaxial or optical cable connections.

Other ways, known in the art, to allow simple PAN networked devices in a PAN to access the Internet are to enable connectivity to wireless LAN access points and/or 3G UMTS mobile phones by means of cheap short range radio link protocols like e.g. Bluetooth.

These different solutions have in common that they make it possible for a user to access the Internet with a simple PAN networked device, without needing to also carry e.g. a mobile phone with long distance connectivity. This common service may be called mobile ad-hoc Internet sharing service.

However, these solutions also introduces problems for users and Internet Service Providers (ISPs) which provide connectivity to the users via wired or wireless long distance links. The problems relates to the fact that the solutions allow different devices, owned by different users, to unobstructedly access the Internet by piggybacking or hi-jacking a connection via an access point registered to only one user. Thus, the services provided by the ISP to one registered user may be utilized by several other unregistered users at the expense of both the registered user and the ISP. Such “unwanted” Internet access utilization would lead to increased costs for the registered user if he e.g. owns a GPRS connection for which the cost increases with increased data traffic. For the ISP, unwanted Internet access utilization may for instance lead to missed income from fixed connection fees and may also lead to uncontrollable network load.

An object of the present invention is to provide an improved solution for provision of mobile ad-hoc Internet sharing.

Another object of the present invention is to provide a method and a system for mobile ad-hoc Internet sharing which allow an ISP and a user to at least indirectly prevent unwanted utilization of the Internet services that the ISP provide.

These and other objects are achieved by means of a method as defined in claim 1 and a system as defined in claim 10. Preferred embodiments of the invention are defined in the dependent claims.

More particularly, according to one aspect of the invention, a method in a system for mobile ad-hoc Internet sharing comprising:

a first portable device that is provided with wireless communication capability and that is enabled to identify a user A of the portable device,

a second device that is provided with wireless communication capability and with capability to connect to the Internet via an Internet Service Provider (ISP), and that is enabled to identify a user B responsible for the connection,

an ISP at which at least user B is a registered user, comprises the following acts:

wirelessly sending information from the first portable device to the second device, for initiating a connection between the first portable device and the ISP,

forwarding the information from the second device to the ISP,

identifying, at the ISP, that the information is sent from user B and originates from user A, and

initiating, at the ISP, registration for charging of an account of user A for said connection.

In the context of this application, wireless communication capability means capability to communicate wirelessly with other devices. The wireless communication capability may be implemented by means of some common protocol for wireless short range communication, wherein “short range” means e.g. up to 100 m. Common protocols for such wireless short range communication are, for example, IEEE 802.11, Bluetooth, Zigbee, HomeRF, HomeCast etc.

An Internet Service Provider (ISP) is herein defined as any organization that provides access to the Internet. Hence, the concept of ISP is herein not restricted to ISPs solely providing Internet access to end users and to other organizations, but also includes e.g. companies providing Internet access to their employees and also mobile phone network providers who also provide Internet access to their customers.

“The Internet” should here be interpreted as either the global Internet, or a Wide Area Network (WAN) which, even if it is rather unusual, may be isolated from the global Internet.

A “connection” should here be interpreted as something that enables communication between two devices. The connection may for example be in the form of a dedicated connection, a packet based connection, tunnelling through the Internet, etc.

According to the present invention, users (A) who do not have access of their “own” to the Internet, i.e. users who do not carry any devices by means of which they may access the Internet directly, may access the Internet via another user (B) who has a direct link to an ISP or is able to establish such a connection. Since, according to the invention, the ISP identifies such an “indirect” user A, the ISP may charge the user A for utilizing the Internet access via the equipment of the other user B.

Hence, the ISP and the user B may by means of the present invention prevent unwanted Internet access sharing, and, further, the ISP may obtain increased income from more users while at the same time the costs for those users who share their Internet access may decrease. The invention thus allows users to provide Internet access to other users in a controlled way, with proper billing fair to all parties involved.

According to the invention, the user B itself does not necessarily need to be personally involved in the connection between the user A and the ISP, e.g. by manually entering an identification code whenever a user A wants to connect via user B. Instead, user B may be automatically identified to the ISP via an account of user B.

According to one embodiment of the present invention, the method further comprises,

initiating, at the ISP, registration for depositing on an account of user B for said connection.

According to this embodiment of the invention, user B may be refunded or in other way paid for sharing his access with other users. This paying is particularly advantageous not only for users who share their Internet access with others, but also for the ISP which thereby may further motivate users to utilize this inventive sharing service instead of allowing other users to utilize their Internet access for free. Another beneficial consequence of this embodiment is that the user B even may receive net earnings from the ISP in case he provides more connectivity to other users than he uses himself.

According to another embodiment of the present invention, the method further comprises,

establishing said connection between said first portable device and said ISP via said second device, and

registering, at said ISP, data relating to utilization of said connection on said account of user A for said charging.

According to this embodiment, the ISP keeps track of the utilization of the connection and may thereby charge user A an amount that is related to the use/time of the connection from user A to the ISP via the device of user B.

According to another embodiment of the invention, the method further comprises,

registering, at said ISP, data relating to utilization of said connection on said account of user B for said depositing.

According to this embodiment, the ISP may further pay user B, who shares his Internet access with user A, an amount that is related to the use/time of the connection from user A to the ISP via the device of user B.

According to yet another embodiment of the invention, the method further comprises, said ISP,

charging said user A for said connection, and

paying said user B for said connection.

According to another embodiment, user A is registered at said ISP. This may give the ISP better control over those who utilize its services.

Alternatively, the user A is a registered user at another ISP. That may give the ISP a larger circle of customers.

In another embodiment of the present invention, said user A is charged by said ISP via a mobile phone subscription of user A. This is advantageous since the user A trusts the mobile phone operator and so the mobile phone operator is effectively acting as a guarantor that the user A will be charged correctly for his or her utilization of the services of the ISP. In this case, the mobile phone operator is either said ISP or another organization which cooperates with said ISP.

In another embodiment of the invention, said act of identifying, at the ISP, that the information sent from the first portable device via the second device originates from a device controlled by user A, comprises the act of receiving identification information from the first portable device, said identification information being provided by a smart card of user A.

This embodiment enables advanced and secure identification of the user A, and eliminates the need for user A to carry around long distance connection functionality in order to identify himself for the ISP.

In yet another embodiment of the invention, communication between said first portable device and said ISP during said connection is encrypted. Thereby, the information communicated between the user A and the ISP may be completely hidden for the device of user B, i.e. user B may not easily interpret information being sent between user A and the ISP.

According to another aspect of the present invention, a communication system for mobile ad-hoc Internet sharing comprises:

a first portable device that is provided with wireless communication capability and that comprises means for identifying a user A of the portable device,

a second device that is provided with wireless communication capability comprising means to wirelessly receive information from said first portable device, and with capability to connect to the Internet via an Internet Service Provider (ISP), said second device further comprising means for identifying a user B responsible for the connection, and means for forwarding said information from said first portable device, and

an ISP at which at least user B is a registered user and has an account for registering utilization of said access to the Internet, said ISP comprising

a receiver being arranged to receive said information being forwarded by said second device,

an identification means being arranged to identify that said information originates from user A,

a connection means for establishing a connection between said first portable device and the ISP via said second device, and

a register for registering charging of an account of user A for said connection.

As mentioned above, the ISP and the user B may by means of the present invention prevent unwanted Internet access sharing while at the same time the ISP may obtain increased income and user B may save money.

In one embodiment of the invention, said ISP further comprises a register for registering depositing on said account of user B for said connection.

As mentioned above, user B may according to this embodiment also obtain net earnings and may thereby be further motivated to utilize this inventive sharing service.

In one embodiment of the invention, said means, of said first portable device, for identifying said user A comprises a smart card being arranged to provide identification information for enabling said identification means of said ISP to identify that the information originates from user A. As mentioned above, this enables advanced and secure identification of the user A and eliminates the need for user A to carry around long distance connection functionality in order to identify himself to the ISP.

In another embodiment of the invention, said first portable device and said ISP comprises means to encrypt communication between the first portable device and the ISP via said second device during said connection. Thereby, as mentioned above, the information communicated between the user A and the ISP may be completely hidden for the device of user B.

These and other aspects of the invention will be apparent from and elucidated with reference to the embodiments described hereinafter.

The present invention will now be described in more detail with reference to the accompanying drawings, in which

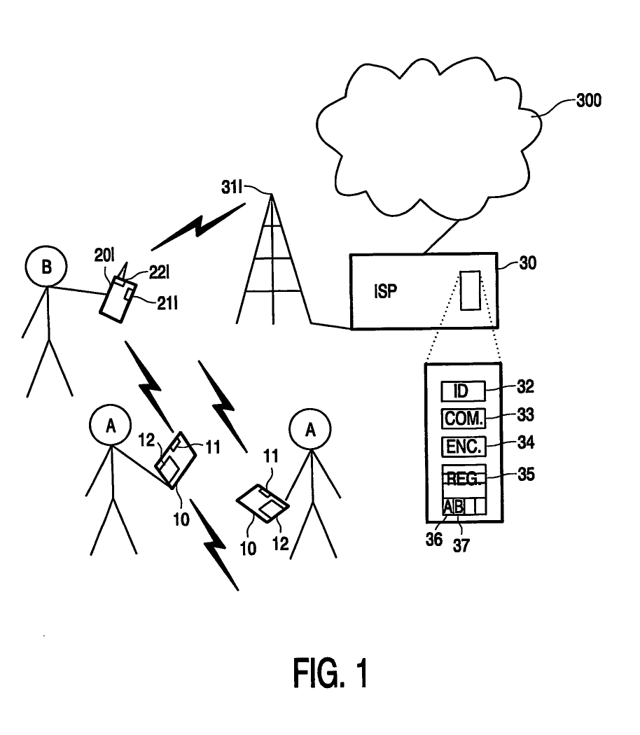

FIG. 1 schematically shows one embodiment of a communication system according to the invention;

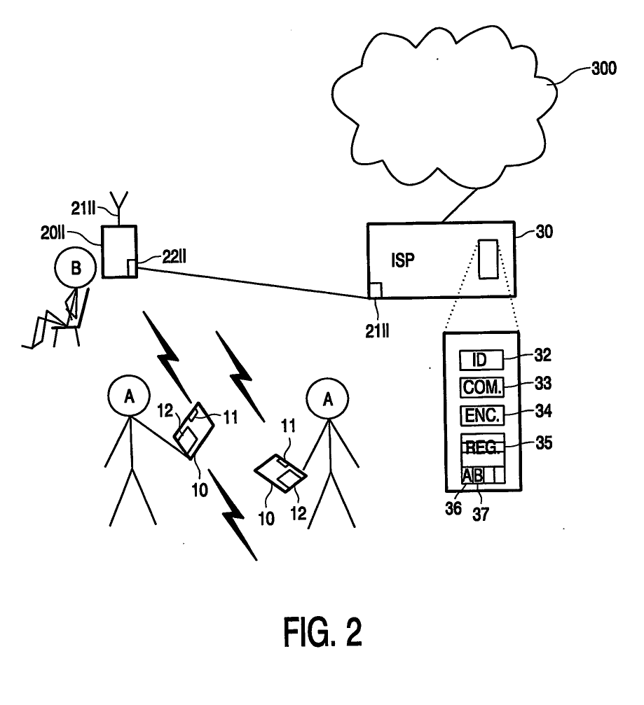

FIG. 2 schematically shows another embodiment of a communication system according to the invention; and

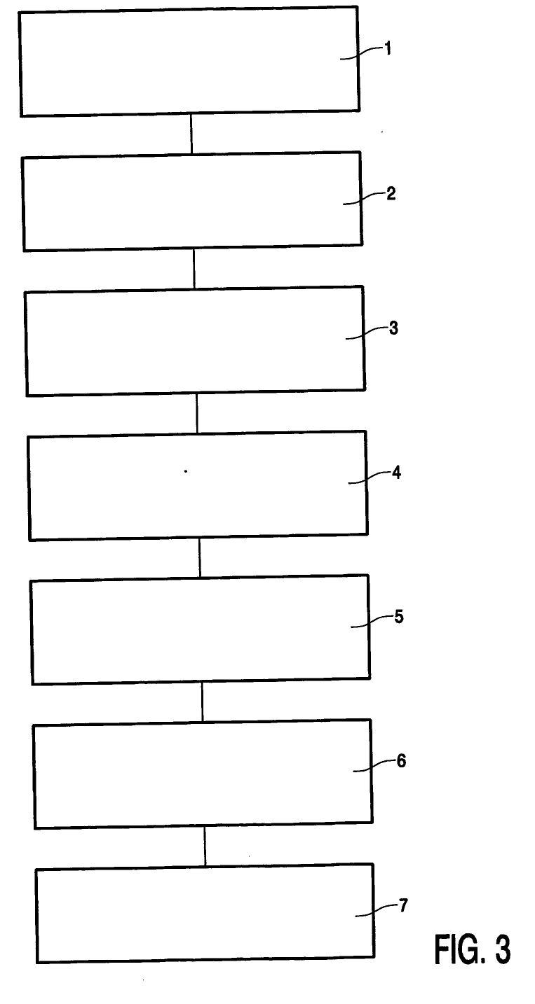

FIG. 3 is a flow chart illustrating the steps of a method according to the invention.

FIG. 1 shows an embodiment of a communication system according to the invention for mobile ad-hoc Internet sharing. The system comprises one or several first portable devices 10, possibly arranged for use in a Personal Area Network (PAN) and controlled by one or several users A, a second device, here in the form of a mobile phone 20I controlled by another user B, and an Internet Service Provider (ISP) 30 providing access to Internet 300.

The first portable device 10 is provided with wireless communication capability 11 and includes means for identifying a user A of the portable device 10. The first portable device 10 may further include means (not shown) to encrypt information being sent to or received from the ISP 30 via the second device.

The first portable device 10 may be any type of portable electronic device, like for example a notebook computer, a Personal Digital Assistant (PDA), a digital camera, an MP3/MD/DVD player, or even a mobile phone.

The wireless communication capability 11 of the first portable device 10 may be achieved by means of some known technology for short range communication, such as 802.11, HomeRF, HomeCast, Bluetooth, Zigbee, etc., e.g. in combination with some higher level protocol such as Universal Plug and Play. These technologies are advantageous in comparison to technologies for long distance communication, like GSM, GPRS or UMTS, in that they are cheaper to implement and in that they usually don't consume as much battery energy. Further, no subscription fees are associated with these technologies.

The means for identifying the user A includes a smart card 12 which is arranged to provide identification information for enabling identification at the ISP 30. The smart card 12 may e.g. be a SIM-card which is commonly used in today's mobile phones, often in combination with entry of a pin code. However, the first portable device 10 must not necessarily include a smart card 12. Other known procedures of identifying user A to the ISP 30, like e.g. entry of an identification code plus a password, may be used as well.

The second device, just like the first portable device 10, is provided with wireless communication capability 21I by means of which it is able to communicate with the first portable device 10.

The second device is also provided with capability to connect to the Internet via the ISP 30, and with means for identifying a user B responsible for the connection. This user B is a registered user at the ISP 30 and has an account there for registering utilization of the access to the Internet.

Further, the second device is provided with means for long distance wireless connectivity, here in the form of a GSM (Global Service Mobile) unit 22I of the mobile phone 20I, for forwarding information being sent from the first portable device 10 to the ISP 30 and vice versa. Other known possible options for long distance wireless connectivity are GPRS (General Packet Radio Standard) and UMTS (Universal Mobile Telephony System).

Additionally, in the second device, or somewhere else in the network, e.g. at the ISP, a list (not shown) of trusted devices may be stored. The trusted devices are devices that are trusted by the second device and that the subscriber of the inventive service, i.e. user B, allows to utilize the access to the network. For instance a Bluetooth enabled MP3-player (as the first device) can connect to a Bluetooth enabled mobile phone (the second device) in order to set up a connection from the MP3-player to the ISP.

The ISP 30 comprises a transceiver, here in the form of a base station 31L which is arranged to receive information which is sent or forwarded by the second device or send information to the second device for forwarding to the first device.

The ISP 30 also comprises an identification means 32 which is arranged to identify that information being sent from the first portable device 10, at least during the initiating procedure, via the second device originates from the user A.

The ISP 30 further comprises a connection means 33 for establishing a connection between the first portable device 10 and the ISP 30 via the second device, and may also comprise means 34 to encrypt communication intended for the first portable device 10.

Moreover, the ISP 30 comprises a register 35 for registering charging of an account 36 of user A and depositing on an account 37 of user B for the utilization of a connection between the first portable device 10 and the ISP 30 via the second device.

As defined earlier, the ISP may be any organization that provides access to the Internet, including companies providing Internet access to their employees and mobile phone network providers who also provide Internet access to their customers.

In an alternative embodiment, where the second device is a mobile phone which connects to an ISP, the information needed for the ISP to identify user B may be stored in the network of a mobile phone network provider which is an organization separated from the ISP. The ISP then has a connection to the mobile phone network to perform the identification and possible authentication.

FIG. 2 shows an alternative embodiment of a system according to the invention. Actually, all that is mentioned above about the embodiment shown in FIG. 1 counts for the embodiment shown in FIG. 2, except that the second device in this embodiment is not a mobile phone, communicating via a GSM, GPRS or UMTS network, but is instead a stationary base station 20II for WLAN, Bluetooth or some other type of wireless network, which base station 20II has a high-speed wired connection, like broadband, cable-modem or ADSL, or some other type of wired connection, to a receiver 31II at the ISP via for example a personal computer or a server at the home or the office of user B.

In FIG. 3, a flow chart illustrating the steps of an embodiment of a method according to the invention is shown.

In step 1, the user A sends information wirelessly from his first portable device 10 to the second device 20I or 20II of user B, which the first portable device 10 may have found by means of a discovery mechanism of a communication method used. The information is sent in order to initiate the establishment of a connection between the first portable device 10 and the ISP 30 via the second device 20I or 20II of user B. The information includes identification, or authentication, information for identifying user A to the ISP. This identification information may, as mentioned above, either be provided by means of a smart card or by means of user A entering an identification code and a password. The information may then be encrypted, by means of e.g. an encryption key stored in the first portable device 10, so that neither user B or anyone else in the communication path may easily interpret the information being sent to the ISP 30.

In step 2, this initiation information received by the second device 20I or 20II may first be checked against the list of trusted devices in order to determine whether the first portable device 10 is a trusted device. If it is, the initiation information is supplemented with information identifying user B to the ISP 30, and then automatically forwarded from the second device 20I or 20II of user B to the ISP 30 via a long distance connection between the second device and the ISP.

In step 3, the ISP 30 identifies that the received initiation information is sent from user B and originates from user A. If the information sent from user A is encrypted, the ISP 30 first identifies user B by means of the identification information added by the second device, then identifies user A by means of the information identifying user A, and thereafter decrypts the encrypted information being sent from user A by means of e.g. a decryption key.

In step 4, the ISP 30 initiates registration for charging of an account of user A for the connection to be established between the first portable device 10 of user A and the ISP 30 via the second device 20I or 20II of user B. Further in step 4, the ISP initiates registration for depositing on an account of user B for the same connection.

In step 5, the connection is established between the first portable device 10 of user A and the ISP 30 via the second device 20I or 20II of user B. As mentioned earlier, the connection may be in the form of a dedicated connection or in the form of a packed based connection, where packets for example may be sent thorough a tunnel between the first portable device 10 and the ISP 30. User A may then by means of this connection access the Internet. Data sent between the first portable device 10 and the ISP 30 via the second device 20I or 20II during the connection may just like the initiation information be encrypted, in both directions.

In step 6, during the established connection, the ISP 30 registers data relating to utilization of the connection on the account of user A for charging, and registers corresponding data on the account of user B for depositing.

In step 7, after the connection is closed, the ISP 30 charges user A for the utilization of the connection and pays user B for the same utilization.

The charging of user A may be made through a mobile phone subscription of user A. As mentioned earlier, this is advantageous because user A trusts the mobile phone operator. This mobile phone operator may be the same organization as the ISP, or alternatively some other organization which cooperates with the ISP.

The paying of user B may also be made through a mobile phone subscription, which would be quite natural if the second device of user B is the mobile phone 20I. The paying of user B may either be in the form of refunding or direct paying for the amount of time, data traffic and/or bandwidth user B shares with other users, or in the form of discount on the price user B pays for his or her own utilization of the Internet access provided by the ISP.

As mentioned earlier, the present invention provides a lot of advantages for both end-users and ISPs. The end-users may with his portable device, by means of the invention, access the Internet with all third party services, or his own home network, without necessarily needing a long distance dial-up networking function in the device. Other users, who carry mobile phones with connectivity to the Internet, or who carry on businesses like hotels, cafes etc., may get incomes from sharing their Internet access to the public.

Another benefit with the invention is that if a user carries for example a notebook computer and a digital camera, but no mobile phone for long distance connection to the Internet, he may use one smart card in order to connect both the notebook computer and the digital camera to an ISP via the device of another user.

This mobile ad-hoc Internet sharing service which the present invention provides may be provided by mobile network operators and other ISPs to any owner of an Internet access network.

It is to be understood that modifications of the above described systems and methods can be made by people skilled in the art without departing from the spirit and scope of the invention. For instance, more advanced ad-hoc networking with intermediate hops or routing points may be envisioned as well, without departing from the scope of the present invention.

1. A method in a system for mobile ad-hoc Internet sharing comprising:
a first portable device that is provided with wireless communication capability and that is enabled to identify a user A of the portable device,
a second device that is provided with wireless communication capability and with capability to connect to the Internet via an Internet Service Provider, and that is enabled to identify a user B responsible for the connection,
an ISP at which at least user B is a registered user, the method comprising
wirelessly sending information from the first portable device to the second device, for initiating a connection between the first portable device and the ISP,
forwarding the information from the second device to the ISP,
identifying, at the ISP, that the information is sent from user B and originates from user A, and
initiating, at the ISP, registration for charging of an account of user A for said connection.

2. A method according to claim 1, further comprising,
initiating, at the ISP, registration for depositing on an account of user B for said connection.

3. A method according to claim 1, further comprising,
establishing said connection between said first portable device and said ISP via said second device, and
registering, at said ISP, data relating to utilization of said connection on said account of user A for said charging.

4. A method according to claim 2, further comprising
registering, at said ISP, data relating to utilization of said connection on said account of user B for said depositing.

5. A method according to claim 1, further comprising, said ISP,
charging said user A for said connection, and
paying said user B for said connection.

6. A method according to claim 1, wherein user A is registered at said ISP.

7. A method according to claim 1, wherein said user A is charged by said ISP via a mobile phone subscription of user A.

8. A method according to claim 1, wherein said act of identifying, at the ISP, that the information sent from the first portable device via the second device originates from a device controlled by user A, comprises the act of
receiving identification information from the first portable device, said identification information being provided by a smart card of user A.

9. A method according to claim 1, wherein communication between said first portable device and said ISP during said connection is encrypted.

10. A communication system for mobile ad-hoc Internet sharing, comprising:
a first portable device that is provided with wireless communication capability and that comprises means for identifying a user A of the portable device,
a second device that is provided with wireless communication capability comprising means to wirelessly receive information from said first portable device, and with capability to connect to the Internet via an Internet Service Provider, said second device further comprising means for identifying a user B responsible for the connection, and means for forwarding said information from said first portable device, and
an ISP at which at least user B is a registered user and has an account for registering utilization of said access to the Internet, said ISP comprising
a receiver being arranged to receive said information being forwarded by said second device,
an identification means being arranged to identify that said information originates from user A,
a connection means for establishing a connection between said first portable device and the ISP via said second device, and
a register for registering charging of an account of user A for said connection.

11. A communication system according to claim 10, further comprising a register for registering depositing on said account of user B for said connection.

12. A communication system according to claim 10, wherein said means, of said first portable device, for identifying said user A comprises a smart card being arranged to provide identification information for enabling said identification means of said ISP to identify that the information originates from user A.

13. A communication system according to claim 10, wherein said first portable device and said ISP comprises means to encrypt communication between the first portable device and the ISP via said second device during said connection.
